(19) United States
(12) Patent Application Publication
(10) Pub. No.: US 2026/0137093 A1
(43) Pub. Date: May 21, 2026

(54) TANK ARRANGEMENT AND METHOD FOR HANDLING BIOMASS

(71) Applicant: MMC First Process AS, Fosnavåg (NO)

(72) Inventors: Roy Steve GLOMSET, Skodje (NO); Leif Roger GJELSETH, Bølandet (NO); Eivind VINJE

(21) Appl. No.: 19/123,525

(22) PCT Filed: Nov. 1, 2023
(86) PCT No.: PCT/NO2023/060082

§ 371 Date: Apr. 23, 2025

(30) Foreign Application Priority Data
Nov. 1, 2022 (NO) 20221172

(51) Int. Cl. A22B 5/04; A22C 25/08; A23B 4/06; B65G 51/01; B65G 53/30

(52) U.S. Cl. CPC A22B 5/04; A22C 25/08; A23B 4/062; B65G 51/01; B65G 53/30

(57) ABSTRACT

A bleeding, cooling and/or freezing arrangement and method for handling biomass, comprising a first tank (1, 2, 3), having a biomass inlet (5), at least one water inlet (15), and a biomass outlet (16). A separator (7) for biomass and water coupled to the biomass outlet (16). A recirculating arrangement comprising recirculating first pump (9) coupled to the separator (7) at an upstream side of the first pump (9), and a return water inlet (11) to the first tank (1, 2, 3) coupled at a downstream side of the recirculating first pump (9). An air pressure source (4) coupled to the first tank (1, 2, 3). The arrangement further comprising a second pump (13) coupled to the separator (7) at an upstream side of the second pump, and a second tank (1, 2 3) coupled to a downstream side of the second pump (13).

### PRIOR FILED APPLICATIONS

The present application is a National Entry of PCT Application No. PCT/NO2023/060082, filed on Nov. 1, 2023, which claims priority to Norwegian Application No. NO 20221172, filed on Nov. 1, 2022. The entire contents of such prior applications are incorporated by reference herein.

### TECHNICAL FIELD

The present invention relates to a bleeding, cooling and/or freezing arrangement for biomass, such as fish and a method for bleeding, cooling and/or freezing of biomass, such as fish. The invention also relates to a method of bleeding, cooling and/or freezing of biomass, such as fish.

### BACKGROUND ART

Fish above a certain size is predominantly killed by cutting the throat of the fish. The killing is done this way not only to quickly kill the fish, but also to let out as much blood as possible from the fish. Blood remaining in the fish may discolour the fishmeat. Discoloured fishmeat results in a lower grade for the fish, and it may be regarded as unfit for human consumption. Hence, as soon as the fish has been cut, it is brought into a vessel containing, preferably cold, water. The cold water will delay the coagulation of the blood, so that as much blood as possible can be drained from the fish.

Biomass, such as seafood, will have to be kept cold to be preserved over any length of time. In some cases, the biomass conveniently has to be frozen to extend the shelf life even further. One method of freezing biomass is to submerge it in or sprinkle it with brine at a sub-zero temperature, such as down to −18° C. or even down to −21° C., which is the coldest temperature a saturated brine may have in liquid state and in atmospheric pressure.

There are known a range of arrangements for propagating the bleeding of the fish:

EP 3367806 shows an arrangement where the killed fish is conveyed through a pipeline through different zones with different properties regarding air pressure and water flow. It relates to a method and system for moving killed fish in a pipe or pipeline. The method involves maintaining a desired water level in the pipe through a water supply system and introducing the fish at the closed end. Pressurized air and/or water pressure are supplied at specific points to create air/water partitions, forming controllable zones with different water flow properties. This controllable water flow propels the fish through the pipe and allows for controlled retention time. The system includes an output device for extracting fish at the open end, as well as various components like pumps, valves, and nozzles to regulate the water supply and air pressure. Sensor means and a control unit are incorporated to monitor and manage the fish movement process. Additionally, the system may feature an integral washing system for cleaning purposes.

WO 1997/01958 shows an arrangement where the fish is subjected to anaesthetics before being cut. The fish is conveyed between tanks with falling temperatures from 10° C. to 1° C. before cutting and into a tank with a water temperature 1,5-2° C. after the cutting.

EP 3599872/WO2018/173078 shows a bleeding tank with a paddle wheel to convey the fish therethrough.

WO2017/074198 describes an arrangement where cut fish is fed through a long horizontal pipeline. At various places along the pipeline, water and pressurized air is introduced to force the fish towards the exit end of the pipeline. At the exit end there is an upwardly sloping flexible pipeline leading the fish to a separation unit where water and fish are separated.

The horizontal pipeline may be pressurized if a valve at the inlet of the fish is closed.

The water that exits the pipeline with the fish is returned to the horizontal pipeline via a pump. The arrangement is intended for continuous operation. Batchwise operation is mentioned, but if the arrangement is run batchwise, the used water has to be discarded between each batch.

WO2020/031215 describes a spiral pump used as a bleeding tank. Water and fish are separated at the outlet of the pump and the water is collected and returned to the inlet of the pump. The operation is continuous.

U.S. Pat. No. 4,826,362 describes an arrangement that can be used in several different modes. In one mode a tank containing fish is set under air pressure by a vacuum pump. A valve is opened at an exit end of the tank and the tank is emptied by the air pressure to a separator that separates fish and water. Separated water is pumped to a source pool for fish or returned to the tank.

NO20210425 is a patent application by the present applicant. It describes an arrangement for handling both live and dead fish without conveying live and dead fish through the same pipes and pumps. In this arrangement the cut fish and water are not separated when the fish is pumped out of the bleeding tanks.

NO20210558 is an at the filing date of the present application unpublished patent application belonging to the present applicant.

### SUMMARY OF INVENTION

The main objective of the present invention is to provide an arrangement and a method of efficient bleed-out, cooling, and/or freezing of biomass. In particular it is an object of the invention to ensure an efficient emptying of the bleed-out, cooling and/or freezing tanks with minimal energy consumption and waste of cold water or brine, and to ensure an even flow of biomass to the processing downstream of the separator.

It is also an object to save space, especially if when the arrangement is on board a boat. Still another object of the invention is to be able to lift the biomass, in particular fish, to a higher level while the fish is still in liquid and to avoid having to use a band conveyor or similar.

These objectives are obtained by the features of the appended claims.

The invention seeks to provide an efficient arrangement where a large capacity of biomass can be distributed via multiple tanks which allows an even flow of fish over a separator and hence to the further processing.

### BRIEF DESCRIPTION OF DRAWINGS

FIG. 1 shows schematically the arrangement of the present invention in a side elevation view, and

FIG. 2 shows schematically the arrangement of the present invention in a planar view.

### DETAILED DESCRIPTION OF THE INVENTION

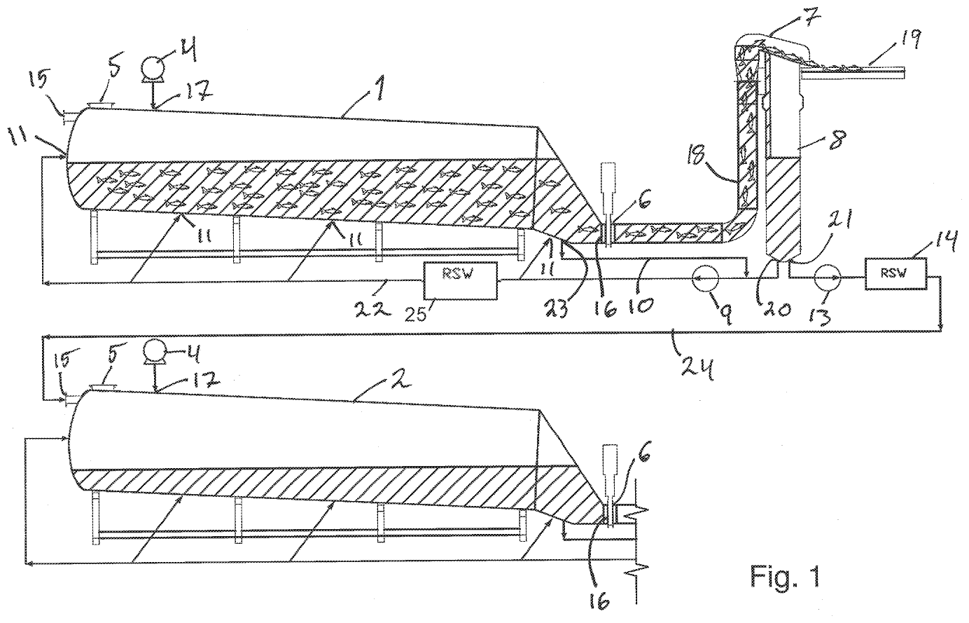

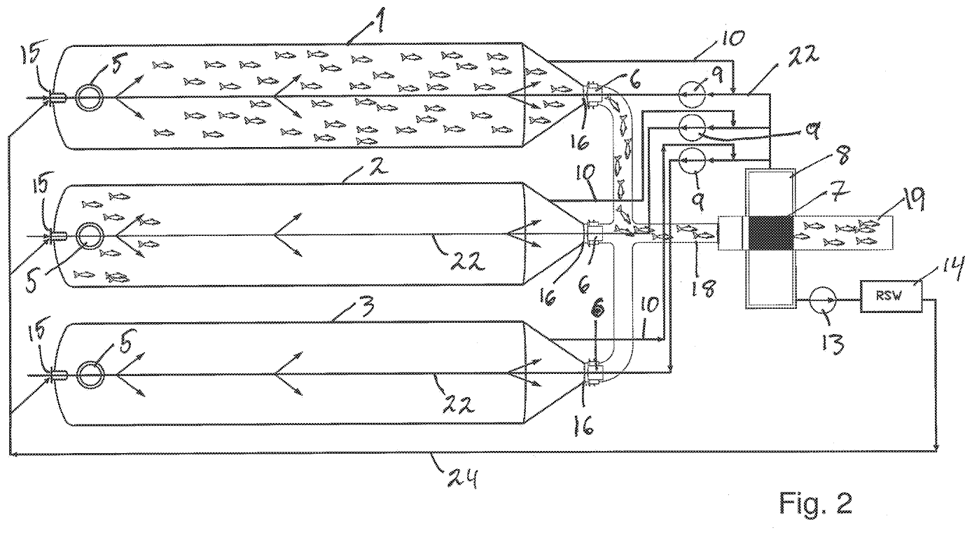

FIGS. 1 and 2 shows the arrangement of the invention in a side elevation view and planar view, respectively. The invention will be described referring to both these figures.

The arrangement comprises at least two bleeding tanks 1, 2, 3. In the embodiment described herein, there are three tanks 1, 2, 3. All three are shown in FIG. 2 but only two in FIG. 1.

The tanks 1, 2, 3 preferably have a circular cylindrical cross-section and a length substantially greater than the diameter, such as 3-6 or more times the diameter. They are preferably arranged at an inclination, such as between 2 and 10 or more degrees, with the inlet end higher than the exit end. The tanks may, however, also be arranged horizontally. The tanks 1,2,3 have a fish inlet 5 at or close to the highest point of the tank. The tanks also have a main water inlet 15 close to the fish inlet 5. Optionally, the fish inlet and the water inlet may be the same inlet.

Further the tanks 1, 2, 3 have a main outlet 16 for fish and water at their lowest points. This outlet is equipped with a valve 6 that can open and close the outlet 16.

The tanks 1, 2, 3 also have a pressurized air inlet 17. This inlet is arranged above the expected highest water level of the tanks. The inlet 17 is coupled to a compressor or other pressurized air source 4. The tanks 1, 2, 3 may have separate air sources 4, but preferably valves are used to control the air supply to each tank from a common source 4.

The outlet 16 is coupled to an exit pipe 18 that extends to an elevation above the highest expected water level of the tank. The exit pipe 18 may be inclined or extend horizontally for some part and then vertically, as shown in FIG. 1.

At the top of the exit pipe 18 is arranged a water and fish separator 7. This contains a grating or other conventional means for separation of fish and water. The fish slides from the separator onto a transporter 19 for further transportation to production, such as filleting and packaging. There may be a separate separator 7 for each tank 1, 2, 3 or, as shown in FIG. 2, a common separator 7 for all tanks. In the latter case it is convenient if the pipes 18 from the outlet of the tanks 1, 2, 3 are joint into one pipe before the pipe 18 extends upwardly to the separator 7.

The separated water runs from the separator 7 down into a buffer tank 8. The buffer tank 8 extends from the separator 7 and down to a level below the lowermost point of the tanks 1, 2, 3.

The buffer tank 8 has a first outlet 20 that connects to a first pump 9 and a second outlet 21 that connects to a second pump 13. The outlets are arranged at or close to the bottom of the buffer tank 8. Alternatively, the outlets 20, 21 may be a single outlet at the buffer tank 8 which branch off outside the buffer tank 8.

There is a separate first pump 9 for each tank 1, 2, 3. The downstream end of each first pump 9 is coupled to a recirculation pipework 22 has inlets 11 into the tank 1, 2, 3. The inlets 11 are arranged at various places along the length of the tank, such as at the end of the tank furthest from the outlet 16 and at the bottom or sides of the tank along its length. The inlets 11 are directed towards the outlet 16. This is done to strengthen the flow towards the outlet when the tank is being emptied, as will be explained further below.

An additional line 10 extends from the tank 1, 2, 3 from a separate outlet 23 close to the main outlet 16 to upstream of the first pump 9.

The second pump 13, which preferably is a common pump for all the tanks 1, 2, 3, is connected at its downstream end to a cooler 14. The cooler is conveniently an RSW (refrigerated seawater) unit, but other types of cooling units may also be used. From the cooler 15 a line 24 extends to the main water inlet 15 of each tank. V alves (not shown) are arranged to direct the water from the cooler 14 to a selected one of the tanks 1, 2, 3.

The arrangement also has a sensor (not shown) in each tank to detect the water level of the tank. A level sensor may also be arranged in the buffer tank 8.

The functioning of the above-described arrangement will now be explained as various embodiments.

First the use of the arrangement for bleed-out, possibly in combination with cooling, will be described. In a first step the first tank 1 has been filled with water. The tank has been filled substantially completely, just leaving room for the fish, which is filled through the fish inlet 5. The fish may be cut fish, but it may also be gutted and already bled-out fish that is to be cooled before further processing, such as freezing. After a predetermined retention time depending on whether the fish is bled-out in the tank or if it is being cooled for further processing, the tank is to be emptied. The retention time may be met during the time it takes to fill and empty the tank.

In order to determine the retention time more accurately, sensors may be disposed in the tanks or the lines coupled to the tanks. The sensors may measure factors such as temperature and salinity.

During the filling of the tank, and possibly also during the retention time, the first pump 9 is used to circulate water via the additional line 10 and back into the tank through the inlets 11. Due to the direction of the inlets 11, a water flow is created towards the exit end of the tank 1. This will ensure that the fish is concentrated towards the exit end of the tank and that the first fish that entered the tank 1 is also the first to exit the tank. The circulation will also ensure proper bleed-out and cooling of the fish. Before the emptying of the tank starts, the circulation through the additional line 10 and the pump is stopped.

The emptying of the tank 1 is performed as follows: A valve (not shown) is opened to let pressurized air from the pressure source 4 into the tank 17 through the air intake 17. The pressure may be between 0.1 bar and 0.5 bar (above atmospheric pressure). It is an advantage if the pressure does not exceed the maximum pressure that equipment may have before they fall under the regulations governing pressurized equipment, which currently is 0.5 bar. The air pressure is gradually increased during the emptying to account for the increased lifting height as the level in the tank 1 is reduced.

With this moderate air pressure in the tank 1, the outlet valve 6 is opened and fish and water are allowed to flow into the exit pipe 18. Due to the air pressure, the water will be lifted to the top of the exit pipe 18 and flow over the separator 7. The water will flow down and into the buffer tank 8. The air pressure is increased as the tank empties to account for the increased lifting height from the water level in the tank to the separator 7.

As the buffer tank 8 fills, the first pump 9 is started again and pumps water from the buffer tank 8 back into the tank 1. This will force the fish in the tank to concentrate towards the exit.

The water level in the buffer tank 8 will level out at about the same level as the water level in the tank 1.

At the same time as water is circulated through the first pump, the second pump 13 is started and pumps a proportion of the water through the cooler 14 and into the second tank 2. The water level in the buffer tank is monitored by one or more level sensors to ensure that the pump 13 does not empty the buffer tank 8 completely and to ensure that the water level in the buffer tank is kept below the separator. Ideally the level in the buffer tank should be kept at about the same height as the water level in the tank 1. When this is the case, the first pump 9 can work very efficiently. With the same water level in the tank 1 and the buffer tank 8 the pressure difference across the first pump 9 will be very low. A low-pressure pump can then be used for the first pump 9. The pump will only have to be able to move the water. This reduces both costs, size and energy consumption.

The recirculation of water through the first pump 9 continues until all the fish in the tank has exited the tank, and only a small amount of water is left at the lowest end of the tank and up through the exit pipe 18. When the first tank 1 has been emptied to this extent, the valve 6 is closed. Fish has then already been introduced into the second tank 2 through its fish inlet 5 and the bleed-out and cooling of the new batch can take place going through the same steps as described for the first tank 1. When the second tank 2 is emptied, the water is gradually pumped through the second pump to the next tank. If there are only two tanks, this will be the first tank 1. It is, however, a great advantage to have at least three tanks 1, 2, 3. Then the arrangement can contain an amount of water sufficient for two tanks, and one tank can be in the process of filling with fish, one tank being in the process of emptying, and one tank being in the process of being filled with water. This ensures an even flow of fish over the separator and hence to the further processing.

If the arrangement of the invention is used for freezing, the tank 1, 2, 3 is first filled about half full of fish, then the remaining volume of the thank is filled with brine at a sub-zero temperature. The temperature may be about −18° C., but it may also be higher or slightly lower. With the tank full of fish and brine, the circulation of brine through the recirculation arrangement, i.e., the additional line 10, first pump 9 and inlets 11, is commenced. A cooler 25 such as an RSW cooler may be arranged in the recirculation loop to keep the brine at the sub-zero temperature.

When a prescribed freezing time has been reached or the sensor measurements indicate that the biomass, such as fish, has reached a predetermined temperature, the brine is removed from the tank 1, 2, 3. This is conveniently done by opening a valve at the outlet 23 and let the brine flow through the additional line 10. The line 10 will then be routed to the cooler 14, or an additional cooler (not shown) and further to a buffer tank (not shown) or to one of the other tanks 1, 2, 3, optionally by gravity alone or via a pump, such as the second pump 13. In this embodiment, the brine is bypassing the exit pipe 18, the separator 7 and the buffer tank 8. To prevent fish from flowing out the outlet 23, a grating or other device holding back fish is arranged at the outlet.

Alternatively, the first tank 1 may be emptied by pressurizing the tank and letting the brine flow to the second pump 13 over the separator 7 and through the buffer tank 8. Conveniently, the bine is pumped to another tank 1, 2, 3, which in the meantime has been filled about half full of fish.

After the brine has been removed from the tank 1, 2, 3, the tank is filled with water having a temperature of about 0° C. The water is recirculated, and the temperature is conveniently kept at about 0° C. by feeding the water through a cooler, such as an RSW cooler (not shown).

When the circulation of the about 0° C. water has continued for a prescribed time and the temperature of the outer portion of the fish has been raised to a target level, the tank is emptied of fish and water in the same way as described above for the emptying after bleed-out and cooling.

An arrangement as described above will provide a substantially even flow of fish across the separator, as one tank always will be in the process of being emptied. This is a great advantage for the further processing of the fish. There will be no congestion of fish along the process line or any waiting time for more fish. This is especially important if the further processing is partly or fully manual. It is common for such processing facilities, whether it is receiving wild caught fish or is processing farmed fish, to hire people for a certain time when a catch is received, or the fish of a pen is to be slaughtered. The more precisely the time that these people are needed, can be estimated, the more predictable the associated costs will be. The need to hire extra persons or persons for an additional time just in case, will be reduced.

1. A bleeding, cooling and/or freezing arrangement for handling biomass, such as fish, comprising a first bleeding, cooling and/or freezing tank (1, 2, 3), having a biomass inlet (5), at least one water inlet (15), and a biomass outlet (16); a separator (7) for biomass and water coupled to the biomass outlet (16); at least one recirculating arrangement, the recirculating arrangement comprising a recirculating first pump (9) coupled to the separator (7) at an upstream side of the recirculating first pump (9), and a return water inlet (11) to the first tank (1, 2, 3) coupled at a downstream side of the recirculating first pump (9); an air pressure source (4) coupled to the first tank (1, 2, 3), wherein the arrangement further comprises a second pump (13) coupled to the separator (7) at an upstream side of the second pump, and a second bleeding, cooling and/or freezing tank (1, 2, 3) coupled to a downstream side of the second pump (13).

2. The bleeding, cooling and/or freezing arrangement of claim 1, wherein a buffer tank (8) is arranged between the separator (7) and the first and the second pumps (9, 13).

3. The bleeding, cooling and/or freezing arrangement of claim 2, wherein the buffer tank (8) is arranged below the separator (7) to enable gravity feeding of water to the buffer tank (8) from the separator (7).

4. The bleeding, cooling and/or freezing arrangement of claim 1, wherein the separator is arranged at a higher level than a highest level of the first and second tanks (1, 2, 3).

5. The bleeding, cooling and/or freezing arrangement of claim 1, wherein the recirculating water inlet (11) is a multiple of inlets arranged at different position along a length of the first tank (1, 2, 3), the inlets being oriented towards the fish outlet (16) of the first tank (1, 2, 3).

6. The bleeding, cooling and/or freezing arrangement of claim 1, wherein the first and the second tanks (1, 2, 3) are placed with their longitudinal axes at an angel relative to the horizontal plane, so that the fish outlet is at a lowest elevation of the tank (1, 2, 3).

7. The bleeding, cooling and/or freezing arrangement of claim 1, wherein a cooler is arranged between the second pump (13) and the second tank (1, 2, 3), and possibly also in the recirculating arrangement.

8. The bleeding, cooling and/or freezing arrangement of claim 1, wherein a water line is arranged between the first tank and the upstream side of the first pump (9) to bypass the separator and a valve at the fish outlet (16).

9. The bleeding, cooling and/or freezing arrangement of claim 1, wherein it comprises a third bleeding, cooling and/or freezing tank, the first, second and third bleeding, cooling and/or freezing tanks being coupled to the same separator, the same buffer tank and the same second pump, but having separate recirculating arrangements.

10. A method of bleeding, cooling and/or freezing of biomass, such as fish, comprising:
a. filling a first bleeding, cooling and/or freezing tank with water and biomass,
b. retaining biomass and water in the first bleeding, cooling and/or freezing tank for a predetermined retention time,
c. pressurizing the first bleeding, cooling and/or freezing tank by an air pressure,
d. opening a biomass outlet to let water and biomass flow to a separator,
e. separating biomass and water in the separator,
f. recirculating a first proportion of the separated water back to the first bleeding, cooling and/or freezing tank,
g. pumping a second proportion of the separated water to a second bleeding, cooling and/or freezing tank,
h. continuing the recirculation and pumping until the first bleeding, cooling and/or freezing tank has been emptied of biomass.

11. The method of claim 10, wherein the air pressure is increased as the first bleeding, cooling and/or freezing tank is emptied.

12. The method of claim 11, wherein the air pressure in the bleeding, cooling and/or freezing tank is kept below a maximum of 0.5 bar.

13. The method of any of claim 10, wherein water is recirculated also during filling of biomass and retention time.

14. The method of claim 10, wherein a buffer tank is arranged downstream of the separator, and that a water level in the buffer tank is monitored and maintained below an outlet from the buffer tank and the separator, preferably at about the same level as the water level in the first bleeding, cooling and/or freezing tank.

15. The method of claim 10, wherein, a third bleeding, cooling and/or freezing tank is coupled to the first and second bleeding, cooling and/or freezing tanks, and that the three bleeding, cooling and/or freezing tanks are operating with a phase difference so that one of the tanks is in the water filling stage, one of the tanks is in a biomass filling stage and one of the tanks is in an emptying stage at the same time.

16. The method of claim 10, wherein step a of claim 10 comprises the following:
a. filling the first bleeding, cooling and/or freezing tank with biomass to a proportion of the volume,
b. filling substantially the remaining volume of the first bleeding, cooling and/or freezing tank with brine at a sub-zero temperature,
c. recirculating the brine through a cooler from an outlet to at least one inlet of the first bleeding, cooling and/or freezing tank,
d. removing the brine from the first bleeding, cooling and/or freezing tank, and
e. filling the first bleeding, cooling and/or freezing tank with water at a higher temperature than the brine.

17. The method of claim 16, wherein the removal of the brine from the first bleeding, cooling and/or freezing tank is done through an outlet at or close to the bottom of the tank, and that the brine flows out by gravity alone or via a pump.
